(19) United States
(12) Patent Application Publication
(10) Pub. No.: US 2021/0179904 A1
(43) Pub. Date: Jun. 17, 2021

(54) MOISTURE-CURING RTV SILICONE COMPOSITION WITH HOMOGENEOUS DEEP-CURE

(71) Applicant: SIKA TECHNOLOGY AG, Baar (CH)

(72) Inventors: Manuel FRIEDEL, Zürich (CH); Rita CANNAS, Dübendorf (CH); Nicolas DANGLETERRE, Gebenstorf (CH)

(73) Assignee: SIKA TECHNOLOGY AG, Baar (CH)

(21) Appl. No.: 17/270,792

(22) PCT Filed: Aug. 23, 2019
(86) PCT No.: PCT/EP2019/072549

§ 371 Date: Feb. 23, 2021

(30) Foreign Application Priority Data
Aug. 24, 2018 (EP) 18190795.7

(51) Int. Cl. C09J 183/06; C09J 183/08; C08L 83/08; C08L 83/06; C08G 77/18; C08G 77/22

(52) U.S. Cl. CPC C09J 183/06; C09J 183/08; C08G 77/22; C08L 83/06; C08G 77/18; C08L 83/08

(57) ABSTRACT

A moisture-curing, condensation-crosslinking silicone composition that can be used as elastic adhesives and sealants. The silicone composition shows homogeneous depth curing, such that it cures through even under movement without forming cracks. The silicone composition contains at least one polyorganosiloxane having Si(OR³)₃ end groups, at least one condensation catalyst and at least one crosslinker having hydrolyzable radicals, characterized in that the polymer end groups Si(OR³) have a reaction rate in the crosslinking reaction that is at least equal to and preferably higher than the hydrolyzable radicals of the at least one crosslinker.

### TECHNICAL FIELD

The invention relates to moisture-curing, condensation-crosslinking silicone compositions, to the use thereof as elastic adhesives and sealants, and to methods of joining and bonding substrates.

### STATE OF THE ART

Silicones are known compositions that have long been used as adhesives or sealants. Such silicones can be configured as one- or two-component silicone compositions and typically contain a polydiorganylsiloxane, a crosslinker and a catalyst as main components. A distinction is made between cold-crosslinking RTV silicones (RTV=room-temperature crosslinking/vulcanizing) and hot-crosslinking HTV silicones (HTV=high-temperature crosslinking/vulcanizing). One- and two-component RTV silicones are also referred to respectively as RTV-1 silicones and RTV-2 silicones.

Moisture-curing, condensation-crosslinking RTV silicones have long been known. It is likewise known that compositions of this kind can be cured on the basis of what is called neutral crosslinking. Conventionally, neutrally crosslinking RTV-1 silicones released oxime compounds, the odor of which is perceived as unpleasant and which are less preferred for reasons of occupational health. Alternatively, neutrally crosslinking RTV-1 silicones can be formulated with crosslinkers or polydiorganylsiloxanes containing alkoxy groups. Neutrally crosslinking RTV-2 silicones are generally based on compounds containing alkoxy groups. The crosslinking elimination products are then alcohols, which have a considerably less unpleasant odor.

The polydiorganylsiloxanes used in moisture-curing, condensation-crosslinking silicones may be terminated by hydroxyl groups. However, it has been found that this type of end group restricts the properties achievable and leads to major problems in the compounding process. Alternatively, the polydiorganylsiloxanes may have been modified with alkyldialkoxysilyl or trialkoxysilyl end groups. Such modified polymers have long been known. The preparation thereof by means of condensation reaction is described, for example, in EP763557 or EP0559045; the preparation thereof by means of hydrosilylation reaction is described, for example, in U.S. Pat. No. 4,898,910.

It is also known that the curing rate of moisture-crosslinking, condensation-crosslinking RTV silicones depends on various factors, including the type and number of hydrolyzable groups. For example, an acetoxy group bonded to a silicon atom will react more quickly in the presence of water than an alkoxy group. If multiple hydrolyzable groups of the same kind are bonded to a silicon atom, the first hydrolyzable group will react more quickly with water than the second, third or fourth group.

It is likewise known that, for good elasticity and especially for crack-free curing of condensation-crosslinking silicones in a joint under movement, under-crosslinking at the back of the joint must be avoided (J. of Adh. Science and Technology (2013), 27(5-6), 551-565). This means that homogeneous depth curing, especially of RTV-1 silicones, is indispensable.

There has therefore been no lack of attempts to prepare polydiorganylsiloxanes having particularly reactive alkyldialkoxysilyl or trialkoxysilyl end groups.

For instance, EP 1013699 and WO 00/37565 disclose polydiorganylsiloxanes containing multifunctional chain ends, obtainable by a hydrosilylation reaction of vinyl-terminated polydiorganylsiloxane with multifunctional Si—H-containing end blockers. Each chain end thus contains a trialkoxysilyl unit, and the presence of a multitude of such chain ends in a polymer chain enables particularly rapid through-curing. One disadvantage is that the polydiorganosiloxanes described in EP1013699 and WO 00/37565 have to be prepared in a complex manner, normally in multistage processes, and are therefore costly.

There is still a need for moisture-curing, condensation-crosslinking silicone compositions that show homogeneous depth curing and overcome the disadvantages of the prior art.

### SUMMARY OF THE INVENTION

It is therefore an object of the present invention to provide a moisture-curing, condensation-crosslinking RTV silicone composition having homogeneous depth curing, which cures through even under movement without forming cracks.

It has been found that, surprisingly, in the case of use of silane and/or siloxane crosslinkers having hydrolyzable alkoxy groups in a condensation-crosslinking RTV-1 silicone, homogeneous depth curing and hence crack-free curing under movement is enabled when polydiorganylsiloxanes modified with trialkoxysilyl groups are used, where the reaction rate of the hydrolysis reaction of the polydiorganylsiloxanes is at least equal to and preferably higher than that of the hydrolyzable alkoxy groups of the crosslinkers.

Accordingly, the invention relates to a moisture-curing, condensation-crosslinking silicone composition comprising
a) at least one crosslinkable polydiorganylsiloxane of the general formula (I)

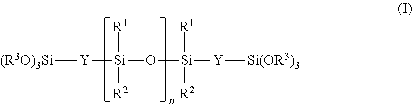

where R¹, R² and R³ are independently monovalent hydrocarbyl groups having 1-8 carbon atoms that may be substituted by F, N, P, O and/or S,
Y is a divalent hydrocarbyl group having 1-8 carbon atoms, an oxygen atom or a group of the general formula (II)

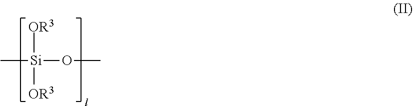

where R³ has the definition given above and I=1-5,
and n is chosen such that the crosslinkable polydiorganylsiloxane has a viscosity at a temperature of 25° C. of 10-500'000 mPa s,
b) at least one condensation catalyst
c) at least one crosslinker having hydrolyzable groups
d) optionally fillers
e) optionally further ingredients,
characterized in that polydiorganylsiloxanes of the general formula (I) account for at least 90%, preferably at least 95%, more preferably at least 99%, of the total mass of polydiorganylsiloxane present, and the polymer end groups Si(OR³) of the at least one polydiorganylsiloxane of the general formula (I) have a reaction rate in the crosslinking reaction that is at least equal to and preferably higher than the hydrolyzable radicals of the c).

The silicone composition of the invention enables homogeneous depth curing and hence crack-free curing under movement. The invention is elucidated in detail hereinafter.

### Ways of Executing the Invention

The viscosities reported here can be determined according to DIN 53018. The measurement can be carried out at 23° C. using an MCR101 cone-plate viscometer from Anton Paar, Austria, with a type CP 25-1 cone. The viscosity values reported relate to a shear rate of 0.5 s⁻¹.

The crosslinking reaction comprises hydrolysis and condensation reactions of alkoxysilyl groups. These are known to the person skilled in the art and can be represented schematically as follows:

≡Si—OR+H₂O→≡Si—OH+ROH (1)

≡Si—OH+HO—Si≡→≡Si—O—Si≡+H₂O (2)

On ingress of water and with or without the aid of a catalyst, alkoxysilyl groups are hydrolyzed to form silanols (Si—OH) and an alcohol (step 1). The silanols are generally unstable and condense spontaneously to form siloxane bonds (—Si—O—Si—), such that siloxanes are formed (step 2). If there is more than one alkoxy group per silicon atom, more highly condensed systems may be formed. In the case of partial hydrolysis, only some of the alkoxy groups are hydrolyzed and condensed. The reaction rate of the crosslinking reaction depends on the kinetics of the component steps. These kinetics can be ascertained, for example, in ¹H NMR and ²⁹Si NMR experiments for single components, as described, for example, in “Zeitschrift für Naturforschung (1999), 54b, 155-164” and “Phosphorus, Sulfur, and Silicone and the Related Elements (2011), 186(2), 240-254”.

The term “homogeneous depth curing” used here means homogeneous curing of a silicone composition in a joint over its entire cross section. This means that the properties, especially mechanical properties such as hardness and elasticity, of the silicone composition after curing on the front side and the reverse side of the joint are the same within the scope of the respective measurement accuracies.

The composition of the invention comprises
a) at least one crosslinkable polydiorganylsiloxane of the general formula (I)

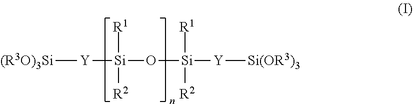

where R¹, R² and R³ are independently monovalent hydrocarbyl groups having 1-8 carbon atoms that may be substituted by F, N, P, O and/or S,
Y is a divalent hydrocarbyl group having 1-8 carbon atoms, an oxygen atom or a group of the general formula (II)

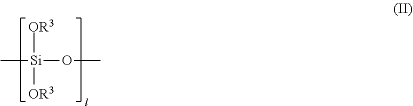

where R³ has the definition given above and I=1-5,
and n is chosen such that the crosslinkable polydiorganylsiloxane has a viscosity at a temperature of 25° C. of 10-500'000 mPa s,
b) at least one condensation catalyst
c) at least one crosslinker having hydrolyzable groups
d) optionally fillers
e) optionally further ingredients,
   characterized in that polydiorganylsiloxanes of the general formula (I) account for at least 90%, preferably at least 95%, more preferably at least 99%, of the total mass of polydiorganylsiloxane present, and the polymer end groups Si(OR³) of the at least one polydiorganylsiloxane of the general formula (I) have a reaction rate in the crosslinking reaction that is at least equal to and preferably higher than the hydrolyzable radicals of c).

The composition of the invention is a moisture-curing, condensation-crosslinking RTV silicone. This may take the form of a one-component composition (RTV-1 silicone), in which all ingredients are mixed and the mixture is stored with exclusion of moisture. Such RTV-1 silicones cure through contact with water, generally through contact with air humidity. Or they may take the form of a two-component composition (RTV-2). Typically, such RTV-2 mixtures take the form of two separate components A and B, of which one component typically has only low reactivity, if any, toward moisture. In the case of such RTV-2 silicones, curing is effected by reaction of constituents of component A with constituents of component B after the two components have been mixed. The composition of the invention preferably takes the form of a one-component RTV-1 silicone composition.

The composition of the invention comprises one or more crosslinkable polydiorganylsiloxanes. Such crosslinkable polydiorganylsiloxanes are well known to the person skilled in the art. The crosslinkable polydiorganylsiloxanes have functional groups, especially two or more functional groups, by means of which crosslinking is possible. These functional groups may be present in a side group or an end group of the polydiorganylsiloxane, preference being given to terminal functional groups. Such polydiorganylsiloxanes having terminal functional groups are also referred to as α,ω-functional polydiorganylsiloxanes. The functional groups of the at least one crosslinkable polydiorganylsiloxane are alkoxy groups.

The viscosity of the polydiorganylsiloxanes used may vary within wide ranges depending on the end use. The polydiorganylsiloxane used in accordance with the invention may, at a temperature of 23° C., for example, have a viscosity of 10 to 500 000 mPa s, preferably of 5000 to 400 000 mPas, more preferably from 10 000 to 320 000 mPas.

The at least one crosslinkable polydiorganylsiloxane is preferably a linear polydiorganylsiloxane, especially a polydiorganylsiloxane of the formula (I)

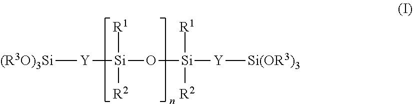

in which R¹ and R² are independently linear or branched, monovalent hydrocarbyl radicals having 1 to 8 carbon atoms, which may optionally be substituted by F, N, P, O and/or S, and optionally have one or more C—C multiple bonds and/or cycloaliphatic and/or aromatic components. The R¹ and R² radicals are preferably independently selected from alkyl groups having 1 to 6, especially having 1 to 3, carbon atoms, such as propyl, ethyl, and methyl, particular preference being given to methyl, where some of the alkyl groups, especially methyl, may be optionally replaced by other groups such as vinyl, phenyl, or 3,3,3-trifluoropropyl. The index n in the general formula (I) is selected such that the polydiorganylsiloxane has the above viscosity, for example, at a temperature of 23° C. The index n in the general formula (I) may, for example, be in the range from 10 to 10 000 and preferably from 100 to 1500.

The at least one crosslinkable polydiorganylsiloxane is an alkoxy-terminated polydiorganylsiloxane, preferably a crosslinkable alkoxy-terminated polydimethylsiloxane. Crosslinkable polydiorganylsiloxanes usable with preference are linear polydiorganylsiloxanes. Alkoxy groups OR³ according to the general formula (I) are independently alkoxy groups having 1 to 8 carbon atoms, which may optionally be substituted by F, N, P, O and/or S. The R³ radicals are independently linear or branched, monovalent hydrocarbyl radicals having 1 to 8 carbon atoms, which may optionally contain one or more heteroatoms F, N, P, O and/or S, and optionally have one or more C—C multiple bonds and/or cycloaliphatic and/or aromatic components.

The R³ radicals may be independently selected, for example, from one or more of the methyl, ethyl, n-propyl, i-propyl, n-butyl, i-butyl, n-pentyl, i-pentyl, n-hexyl, i-hexyl, n-heptyl, i-heptyl, n-octyl, i-octyl, cyclopentyl, cyclohexyl, phenyl, vinyl, allyl, methoxymethyl, 2-methoxyethyl, ethoxymethyl, 2-(2-methoxyethoxy)ethyl, trifluoropropyl, 2-aminoethyl, 6-aminohexyl groups.

The R³ radicals are preferably independently selected from alkyl groups having 1 to 6, especially having 1 to 3, carbon atoms, such as propyl, methyl and ethyl, particular preference being given to ethyl.

In a particular embodiment, all R³ radicals are the same and are selected from alkyl groups having 1 to 6, especially having 1 to 3, carbon atoms, such as propyl, methyl and ethyl, particular preference being given to ethyl.

Y is a divalent hydrocarbyl group having 1 to 8 carbon atoms, preferably having 2 to 6 carbon atoms, more preferably an ethylene or hexylene bridge, or an oxygen atom, or a group of the general formula (II)

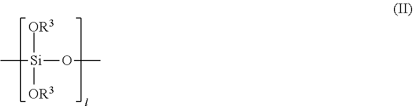

where R³ has the definition given above and I=1-5,

The polydiorganylsiloxanes of the general formula (I) account for at least 90%, preferably at least 95%, more preferably at least 99%, of the total mass of polydiorganylsiloxane present in a composition of the invention.

Polydiorganylsiloxanes of the general formula (I) can be prepared by condensation reaction of OH-terminated polydiorganylsiloxanes with alkoxy-functional silanes or siloxanes. Preparation by condensation reaction can be effected by methods as described, for example, in EP763557 or EP0559045. Alternatively, polydiorganylsiloxanes of the general formula (I) may be prepared by hydrosilylation reaction of vinyl-terminated polydiorganylsiloxanes with Si—H-functional alkoxysilanes or -siloxanes or of Si—H-terminated polydiorganylsiloxanes with vinyl-functional alkoxysilanes or -siloxanes. Preparation by hydrosilylation reaction can be effected by methods as described, for example, in U.S. Pat. No. 4,898,910.

In a preferred embodiment, polydiorganylsiloxanes of the general formula (I) are prepared by condensation reaction of OH-terminated polyorganosiloxanes with alkoxy-functional silanes or siloxanes. In a particularly preferred embodiment, polydiorganylsiloxanes of the general formula (I) are prepared by condensation reaction of OH-terminated polydiorganylsiloxanes with alkoxy-functional silanes or siloxanes under catalysis by amidines or guanidines, optionally under co-catalysis by a metal catalyst. Suitable amidine and guanidine catalysts are described, for example, in WO 2016/207156 and in WO 2015/193208.

The composition of the invention also comprises at least one crosslinker having hydrolyzable groups. Hydrolyzable groups here are understood to mean groups that can react with the functional groups of the polydiorganylsiloxane to form a siloxane bond. The reaction between functional groups of the polydiorganylsiloxane and hydrolyzable groups of the crosslinker is preferably effected by a condensation reaction, optionally following a hydrolysis reaction. In general, this releases by-products such as water or alcohol.

Crosslinkers of the invention having hydrolyzable radicals conform to the general formula (III)

R⁴ₘSiX₄₋ₘ (III)

where R⁴ is independently a nonhydrolyzable monovalent hydrocarbyl radical having 1 to 18 carbon atoms, which is saturated or unsaturated and optionally has one or more functional groups containing the elements F, N, P, O and/or S, m is 0, 1, 2 or 3, preferably 0 or 1, X is independently an OH group, a linear or branched alkoxy group having 1 to 8 carbon atoms, which may optionally substituted by F, N, P, O and/or S and optionally has unsaturated and/or cycloaliphatic and/or aromatic components, or a group of the general formula (IV)

N(SiR⁴ₘ)ₒ(R⁵)ₚ(R⁶)_{q} (IV)

where R⁴ and m have the definitions given above, R⁵ is a hydrogen atom or a monovalent hydrocarbyl group having 1 to 8 carbon atoms and R⁶ is an acyl group having 1 to 9 carbon atoms, and o, p, q are 0, 1 or 2, with the proviso that o+p+q=2.

If X is an alkoxy group, alkoxy groups X are independently alkoxy groups having 1 to 8 carbon atoms, which may optionally be substituted by F, N, P, O and/or S and optionally have unsaturated and/or cycloaliphatic and/or aromatic components. The alkoxy groups X may, for example, independently selected from one or more of the methoxy, ethoxy, n-propoxy, i-propoxy, n-butoxy, butoxy, n-pentoxy, i-pentoxy, n-hexoxy, i-hexoxy, n-heptoxy, i-heptoxy, n-octoxy, i-octoxy, cyclopentoxy, cyclohexoxy, phenoxy, vinyloxy, allyloxy, methoxymethoxy, 2-methoxyethoxy, ethoxymethoxy, 2-(2-methoxyethoxy) ethoxy, trifluoropropoxy, 2-aminoethoxy, 6-aminohexoxy groups.

The alkoxy groups X are preferably independently selected from alkoxy groups having 1 to 6, especially having 1 to 3, carbon atoms, such as propoxy, ethoxy and methoxy, particular preference being given to ethoxy.

In a particular embodiment, all X groups are the same and are selected from alkoxy groups having 1 to 6, especially having 1 to 3, carbon atoms, such as propoxy, ethoxy and methoxy, particular preference being given to ethoxy.

If X is a group of the general formula (IV), R⁴ and m have the definitions given above and the R⁵ are independently a hydrogen atom or a monovalent hydrocarbyl group having 1 to 8 carbon atoms, preferably a linear hydrocarbyl group having 1 to 4 carbon atoms, more preferably methyl, and the R⁶ are independently an acyl group having 1 to 9 carbon atoms, especially an acetyl group and/or a benzoyl group, and o, p, q are 0, 1, 2, with the proviso that o+p+q=2.

Examples of crosslinkers of the general formula (III) are methyltrimethoxysilane, dimethyldimethoxysilane, ethyltrimethoxysilane, propyltrimethoxysilane, i-butyltrimethoxysilane, octyltrimethoxysilane, hexadecyltrimethoxysilane, vinyltrimethoxysilane, vinyltris(2-methoxyethoxy)silane, vinyldimethoxymethylsilane, phenyltrimethoxysilane, tetramethyl orthosilicate, 3-methacryloyloxypropyltrimethoxysilane, 3-mercaptopropyltrimethoxysilane, 3-aminopropyltrimethoxysilane, 3-glycidoxypropyltrimethoxysilane, 3-aminopropyltrimethoxysilane, 2-aminoethyl-3-aminopropyltrimethoxysilane, (trimethoxysilyl)methyl O-methylcarbamate, N-((trimethoxysilyl)methyl)methacrylamide, N-(trimethoxysilyl)methyl)cyclohexanamine, N,N′-(methoxy(methyl)silanediyl)dibenzamide and the corresponding compounds in which all methoxy groups have been replaced either by ethoxy groups or by propoxy groups, i.e., for example, methyltriethoxysilane etc.

In a preferred embodiment of the invention, all X groups are alkoxy groups, more preferably methoxy and/or ethoxy groups.

According to the above description, crosslinkers of the general formula (III) may be wholly or partly hydrolyzed and may be condensed to form siloxanes. Such condensed siloxanes may be prepared from one or more different crosslinkers of the general formula (III), where at least one of the parent crosslinkers is a trialkoxysilane or a tetraalkoxysilane, and where the average condensation level of the siloxane is at least 4. The siloxane is thus preferably a condensation product of the monomeric alkoxysilanes of the general formula (III) that contains alkoxy groups.

It is possible to use mono-, di-, tri- or tetraalkoxysilanes or mixtures thereof for the partial hydrolysis and condensation, at least one alkoxysilane being a tri- or tetraalkoxysilane. Depending on the alkoxysilanes used and the reaction regime, especially the amount of water added, it is possible to adjust the level of condensation and the proportion of alkoxy groups remaining in the siloxane formed, where the average condensation level of the siloxane is at least 4. The siloxane may consist of linear and/or branched chains, rings or cages. It will be clear to the person skilled in the art that mixtures of such structural elements are usually present. The alkoxysilanes may have nonhydrolyzable groups bonded to the silicon atom, especially monovalent hydrocarbyl radicals optionally having one or more functional groups, which remain in the siloxane formed. The alcohol formed as a by-product may be removed, for example by evaporation under reduced pressure. Siloxanes containing alkoxy groups that are formed therefrom are known and commercially available.

In addition, it is also additionally possible to use monoalkoxysilanes and/or dialkoxysilanes for preparation of the siloxane containing alkoxy groups. Examples are trimethylmethoxysilane, triethylmethoxysilane, triphenylmethoxysilane, dimethyldimethoxysilane, diethyldimethoxysilane and diphenyldimethoxysilane, and the corresponding silanes in which all methoxy groups have been replaced either by ethoxy groups or propoxy groups. The monoalkoxysilanes and/or dialkoxysilanes may be used, for example, in order to adjust the condensation level or the branching of the siloxane formed.

Preferred tri- or tetraalkoxysilanes that are used for preparation of the siloxane containing alkoxy groups are methyltrimethoxysilane, methyltriethoxysilane, vinyltrimethoxysilane, vinyltriethoxysilane, n-propyltrimethoxysilane, n-propyltriethoxysilane, phenyltrimethoxysilane, phenyltriethoxysilane, 2-aminoethyl-3-aminopropyltrimethoxysilane, 2-aminoethyl-3-aminopropyltriethoxysilane, 3-glycidoxypropyltrimethoxysilane, 3-glycidoxypropyltriethoxysilane, 3-mercaptopropyltrimethoxysilane, 3-mercaptopropyltriethoxysilane, tetraethoxysilane, tetramethoxysilane, and mixtures thereof.

Also present in the composition of the invention are one or more condensation catalysts. These serve for catalysis of the hydrolysis and condensation that take place between the crosslinkable polydiorganylsiloxane and the crosslinker in the presence of moisture or water.

The condensation catalyst may be any customary catalyst used for these systems, preferably a metal catalyst. Metal catalysts may be compounds or complexes of elements of groups 1, 2, 4, 12, 14 or 15 of the Periodic Table of the Elements, preferably of group 4 or 14. The condensation catalyst is preferably an organotin compound or a titanate or organotitanate. The condensation catalyst is most preferably an organotin compound. These are commercially available. It is also possible and even preferred in certain cases to use mixtures of different catalysts.

Preferred organotin compounds are dialkyltin compounds, selected for example from dimethyltin di-2-ethylhexanoate, dimethyltin dilaurate, di-n-butyltin diacetate, di-n-butyltin di-2-ethylhexanoate, di-n-butyltin dicaprylate, di-n-butyltin di-2,2-dimethyloctanoate, di-n-butyltin dilaurate, di-n-butyltin distearate, di-n-butyltin dimaleate, di-n-butyltin dioleate, di-n-octyltin di-2-ethylhexanoate, di-n-octyltin di-2,2-dimethyloctanoate, di-n-octyltin dimaleate, di-n-octyltin dilaurate, di-n-butyltin oxide, and di-n-octyltin oxide.

Suitable organotin compounds may be purchase commercially, for example, from TIB, Germany.

Titanates or organotitanates refer to compounds having at least one ligand bonded to the titanium atom via an oxygen atom. Suitable ligands bonded to the titanium atom via an oxygen-titanium bond are, for example, those selected from an alkoxy group, sulfonate group, carboxylate group, dialkylphosphate group, dialkylpyrophosphate group and acetylacetonate group. Preferred titanates are, for example, tetrabutyl or tetraisopropyl titanate. Further suitable titanates have at least one polydentate ligand, also called chelate ligand. In particular, the polydentate ligand is a bidentate ligand.

Suitable titanates are commercially available, for example, under the Tyzor® AA-105, PITA, TnBT, TPT, TOT, IAM, IBAY trade names from Dorf Ketal, India.

The proportions of the above-elucidated constituents may vary within wide ranges. For example, the at least one polydiorganylsiloxane of the general formula (I) may be present at 20% to 75% by weight, preferably 25% to 60% by weight, more preferably 30% to 50% by weight, based on the overall composition of the silicone mixture. The at least one crosslinker of the general formula (III) may be present, for example, at 0.1% to 8% by weight, preferably 0.3% to 5% by weight. Any lower content of the at least one crosslinker of the general formula (III) may lead to an unfavorably short skin time and inadequate storage stability. The condensation catalyst may be present, for example, at 0.001% to 5% by weight, preferably 0.01% to 3% by weight.

The silicone composition optionally includes one or more fillers. The fillers may influence, for example, both the rheological properties of the uncured composition and the mechanical properties and surface characteristics of the cured composition. It may be advantageous to use various fillers in one composition.

The composition of the invention may contain, for example, 10% to 70% by weight, preferably 10% to 50% by weight, of fillers.

Examples of suitable fillers are inorganic or organic fillers, such as natural, ground or precipitated calcium carbonates or chalks, that have optionally been surface-treated, for example with fatty acids, silicas, especially fumed silicas, that have optionally been surface-treated, for example with silicone oils, aluminum hydroxides such as aluminum trihydroxide, carbon black, in particular industrial carbon blacks, barium sulfate, dolomite, siliceous earths, kaolin, hollow beads, quartz, calcined aluminum oxides, aluminum silicates, magnesium aluminum silicates, zirconium silicates, cristobalite flour, diatomaceous earths, mica, titanium oxides, zirconium oxides, gypsum, graphite, carbon fibers, zeolites or glass fibers, the surface of which has optionally been treated with a hydrophobizing agent.

The composition of the invention preferably does not contain any precipitated silica since this can impair the storage stability of the composition.

The composition of the invention may optionally also comprise further constituents as customary for moisture-curing, condensation-crosslinking silicone compositions. Such additional constituents are, for example, OH-terminated polydimethylsiloxanes, plasticizers, adhesion promoters, curing accelerators, OH scavengers, desiccants, wetting aids, rheology modifiers, thixotropic agents, processing aids, biocides, UV stabilizers, heat stabilizers, flame retardants, color pigments, odorants, antistats, emulsifiers.

If OH-terminated polydimethylsiloxanes are used as a further constituent, silicone compositions of the invention contain at least 90%, preferably at least 95%, more preferably at least 99%, of polydiorganylsiloxanes of the general formula (I) based on the total mass of the polydiorganylsiloxane used. The weight ratio of polydiorganylsiloxanes of the general formula (I) to OH-terminated polydimethylsiloxanes is accordingly at least 9:1, preferably at least 9.5:0.5, more preferably at least 9.9:0.1.

An example of plasticizers that may optionally be used is trialkylsilyl-terminated polydimethylsiloxanes, the trialkylsilyl-terminated polydimethylsiloxanes preferably having a viscosity at 23° C. in the range from 1 to 10 000 mPa s. For example, it is also possible to use trimethylsilyl-terminated polydimethylsiloxanes in which some of the methyl groups have been replaced by other organic groups such as phenyl, vinyl or trifluoropropyl groups. The polydimethylsiloxane may also be monofunctional, i.e. reactive at one end, for example via a hydroxy end group. Certain hydrocarbons may likewise be used as plasticizers. Suitable hydrocarbons may be purchased commercially, for example, under the Hydroseal G 232 H trade name from Total.

Examples of adhesion promoters that may optionally be used are amino alcohols such as triethanolamine or amine-containing polyols that are commercially available, for example, under the Jeffamin® trade name. Compounds containing silyl groups and bearing hydrolyzable radicals on the silicon atom, especially aminosilanes, for example 3-aminopropyltrimethoxysilane, are assigned to the crosslinkers of the general formula (III) since they can take part in the crosslinking reaction.

It may be advantageous to combine two or more adhesion promoters.

The curing accelerators that are optionally used are compounds that accelerate the crosslinking of the moisture-curing, condensation-crosslinking composition when they are used together with the condensation catalysts of the invention. Examples of such curing accelerators are guanidines, especially silylated guanidines or oligodiorganylsiloxanes modified with guanidine groups, diorganosulfoxides, imidazoles, especially alkylated imidazoles such as N-methylimidazole or benzimidazole, amidines, especially silylated amidines, or oligodiorganylsiloxanes modified with amidine groups or cyclic amidines such as 1,8-diazabicyclo[5.4.0]undec-7-ene (DBU) and amines, especially alkylamines such as triethylamine, or silylated amines such as N-butyl-3-aminopropyltrimethoxysilane. Curing accelerators containing alkoxysilyl groups simultaneously also act as crosslinker.

Curing accelerators may be added in amounts of 0% to 5% by weight, preferably of 0.01% to 2% by weight, based on the total weight of the moisture-curing composition. The curing accelerator may consist of a single substance or a mixture of two or more substances.

The OH scavengers that are optionally used are compounds that react with any OH groups present. OH groups may be present as unsealed chain ends of polydiorganylsiloxanes, as OH groups on fillers, and as water. OH scavengers may be Si—N-containing compounds. Examples of OH scavengers are hexamethyldisilazane (HMDS), hexamethylcyclotrisilazane, octamethyltetrasilazane, bis(trimethylsilyl)urea. HMDS is the most preferred OH scavenger.

The constituents of the moisture-curing, condensation-crosslinking composition may be mixed with one another in a customary manner. For this purpose, the individual components are mixed intimately with one another in suitable mixing units, for example forced action mixers, planetary mixers, mixing tubes, kneaders, dissolvers or extruders. The mixing can be effected continuously or batchwise. The inventive crosslinkable polydiorganylsiloxane of the general formula (I) may be prepared here in an upstream, spatially separate reaction, optionally stored intermediately, and then metered into the mixing unit in a suitable amount. Alternatively, it is also possible, and generally preferable, to prepare the crosslinkable polydiorganylsiloxane of the general formula (I) directly in the mixing unit as described further up, and to meter and mix in the further ingredients on conclusion of this preparation, without workup and/or intermediate storage of the polydiorganylsiloxane of the general formula (I).

The composition of the invention may be a two-component composition consisting of a component A comprising
a) the at least one crosslinkable polydiorganylsiloxane of the general formula (I)
b) optionally fillers
c) optionally further ingredients
and a component B comprising
a) the at least one condensation catalyst
b) the at least one crosslinker having hydrolyzable radicals
c) optionally fillers
d) optionally further ingredients.

Components A and B of the two-component moisture-curing composition are stored separately from one another for storage. The mixing of components A and B can be effected in a customary manner, for example by stirring component B) into component A), which can be effected manually or with the aid of a suitable stirring apparatus, for example with a static mixer, dynamic mixing, Speedmixer, dissolver etc. For the application or introduction, the two components can also be expressed from the separate storage containers, for example with gear pumps, and mixed. The mixing can be effected, for example, in feed conduits or nozzles for the application or introduction, or directly on the substrate or in the joint.

The composition of the invention may be a one-component composition. In a preferred embodiment, the composition of the invention is a one-component composition.

The composition of the invention may be used as an adhesive or sealant in a method of bonding or joining substrates. The method of the invention comprises
a) if appropriate mixing component B into component A in order to obtain a mixture,
b) applying the mixture to a substrate and contacting the mixture applied to the substrate with a further substrate in order to obtain an adhesive bond between the substrates, or introducing the mixture into a joint between two substrates in order to obtain a joint between the substrates, and
c) curing the mixture,
wherein the mixing-in in step a) is conducted before or during the application or introduction in step b).

The mixing-in in step a) can thus be conducted before or during the application or introduction in step b). The mixing should be effected relatively shortly before the further processing since the mixing commences the curing process. Naturally, step a) is dispensed with when using an RTV-1 formulation.

Application to a substrate or introduction into a joint between substrates in step b) can be effected in a customary manner, for example manually or in an automated process with the aid of robots. During bonding, the substrate provided with the mixture is contacted with a further substrate, optionally under pressure, in order to obtain an adhesive bond between the substrates. Thereafter, the mixture is left to cure in step c), usually at room temperature, in order to achieve the bonding or joining of the substrates. In this way, the bonded or joined substrates of the invention are obtained with the cured mixture as adhesive or sealant material.

The substrates to be bonded or joined may be of the same material or a different material. It is possible to bond or join any customary materials with the two-component composition of the invention. Preferred materials for bonding or joining are glass, metals, such as aluminum, copper, steel or stainless steel, concrete, mortar, building stones such as sandstone and sand-lime brick, asphalt, bitumen, plastics, such as polyolefins, PVC, Tedlar, PET, polyamide, polycarbonate, polystyrene or polyacrylate, and composite materials such as CFRP.

The two-component composition of the invention may thus be used as an adhesive or sealant, for example in the following sectors: construction, the sanitary sector, the automotive sector, solar power, wind power, white goods, facade and window construction, electronics, and boat- and shipbuilding.

### EXAMPLES

Specific embodiments of the invention are described hereinbelow, but are not intended to limit the scope of the invention. The amounts are stated in phr (parts per hundred rubber) and are each based on 100 parts by mass of the polydiorganylsiloxane. All tests were conducted at 23° C. and 50% RH (relative humidity).

The proportions of the constituents for the silicone compositions given in the tables below were weighed out successively and mixed on a Hauschild SpeedMixer at 23° C. and 50% RH for 20 s at 2000 rpm with application of reduced pressure. The compositions obtained were sealed airtight, stored at 23° C. for 24 h and then tested.

In order to determine skin times (ST), the composition to be tested was painted on over an area of about 20 cm² with a thickness of about 1 cm. It was ensured that the surface was smooth. The time of painting marked the commencement of the measurement. A PE pipette was used to touch the surface of the curing composition. The skin time was attained when the PE pipette was removable without any visible adhesion.

The through-curing time was determined using a Teflon wedge. This wedge was produced from a piece of Teflon of mass 340×30×30 mm. For this purpose, a wedge of mass 300×10 mm was machined out of the surface of this piece of Teflon, this wedge having a depth of 20 mm at one end—the deep end—and tapering to the surface of the piece of Teflon at the other—the flat end. The slope in the wedge is constant from one into the other. From the deep end, this wedge was filled with the composition to be tested. The surface was smoothed with a spatula. Through-curing was tested by pulling out the hardened composition from the flat end of the wedge until adhering material became visible on the base and/or walls of the wedge. The depth of through-curing was determined after 24 h, 3 d, 7 d.

Shore A hardness was determined after curing on a Shore A hardness tester from Bareiss in accordance with DIN ISO 7619-1 for 7 d. For determination of Shore A hardness, round test specimens having a diameter of 42 mm and a thickness of 6 mm were produced.

Tensile strengths and elongations at break were determined to ISO 37 on S2 dumbbells using a Zwick Z010 tensile tester. For this purpose, the compositions were knife-coated to give sheets of thickness 2 mm and cured for 7 d.

Curing under movement was measured by the method that follows. The silicone compositions were applied to a joint of dimensions 120×20×20 mm in a stainless steel mold that was movable about its middle and had a PE backer rod (radius 5 mm). The substrates were not pretreated. After the surfaces had been smoothed, the silicone composition was left to cure at 23° C./50% RH for 24 h. Then the joint was stretched with a spacer, or compressed. For this purpose, the spacer was mounted 60 mm from the middle and was 30 mm wide. It followed that the maximum stretch/compression of the silicone compositions was 75%. Curing of the silicone compositions was continued at 23° C./50% RH under stretching/compression for 24 h. Then the spacer was removed and reinserted at the opposite end of the joint. The joint was thus stretched, or compressed, by the same magnitude at the opposite end. The silicone compositions were cured in the loaded state at 23° C./50% RH for a further 4 days, then the spacer was removed and, after a further 24 h at 23° C./50% RH in the unladen state, the cured silicone composition was cut out and assessed visually for cracks in the silicone.

Abbreviations of chemicals used can be found in table 1 below. All polymers are based on linear polydimethylsiloxane (PDMS). All chemicals, unless stated otherwise, are commercially available in the chemicals trade (e.g. Sigma-Aldrich).

TABLE 1

| Name | Description |
|---|---|
| Polymer 1 | PDMS, 20'000 mPa s, end group capped with tetraethyl |
| | orthosilicate. The end groups are oligo(ethoxysilyl). |
| Polymer 2 | PDMS, 20'000 mPa s, end group capped with tetraethyl |
| | orthosilicate. The end groups are oligo(ethoxysilyl). |
| Polymer 3 | PDMS, 65'000 mPa s, with trimethoxysilylethyl end |
| | groups. The end groups are trimethoxysilylethyl. |
| Polymer 4 | PDMS, 50'000 mPa s, end group capped (Polymer NG |
| | 410 50 T from Wacker Chemie AG). The end groups are |
| | methyldimethoxysilyl. |
| Polymer 5 | PDMS, 80'000 mPa s, end group capped with a mixture |
| | of methyl-and vinyltrimethoxysilane (Polymer Al100 |
| | from Wacker Chemie AG). The end groups are |
| | vinyldimethoxysilyl and methyldimethoxysilyl. |
| Silicone oil | PDMS, 1'000 mPa s, with trimethylsilyl end groups |
| | (AK1000 silicone oil from Wacker Chemie AG). |
| Crosslinker 1 | Methyltrimethoxysilane |
| Crosslinker 2 | 2-Aminoethyl-3-aminopropyltriethoxysilane |
| Silylurea | Bis(trimethylsilyl)urea, 50% in silicone oil (Alkoxy |
| | stabilizer from Wacker Chemie AG). |
| Silica 1 | Fumed silica, BET: 150 m2/g |
| Silica 2 | Fumed silica, BET: 200 m2/g, hydrophobized with |
| | HMDS |
| GCC | Ground chalk, untreated, d50: 5 μm |
| Catalyst 1 | Dibutyltin oxide, reaction product with tetraethoxysilane |
| | (catalyst 41 from Wacker Chemie AG) |
| Catalyst 2 | Dioctyltin dilaurate |

The preparation of the catalysts used for synthesis of polymer 1 and polymer 2 is described in WO 2016/207156, in WO 2013/087680, and in WO 2015/193208.

### Preparation of Polymer 1

100 g of linear OH-PDMS having a viscosity of 20'000 mPa s was mixed with 9 g of tetraethyl orthosilicate. Added to this reaction mixture were 55 mg of 1-(2-hydroxy-3-(3-triethoxysilylpropoxy)prop-1-yl)-2-methyl-1,4,5,6-tetrahydropyrimidine and 1 g of zinc(II) bis(N,N-dibutyl-3-oxoheptanamidate). The mixture was stirred at 40° C. for 14 h. Subsequently, it was no longer possible to detect any gelation on addition of a few drops of tetra-n-propyl orthotitanate to a small sample of the polymer, which indicates the completeness of the reaction. The mixture was neutralized by adding 2 mg of neodecanoic acid. The resulting polymer is storage-stable and can be used further without further workup.

### Preparation of Polymer 2

100 g of linear OH-PDMS having a viscosity of 20'000 mPa s was mixed with 9 g of tetraethyl orthosilicate. Added to this reaction mixture were 33 mg of 1,1′-(α,ω-n-propyl-poly(dimethylsiloxane))bis(2,3-dicyclohexylguanidine) and 12 mg of catalyst 1 (see table 1). The mixture was stirred at 40° C. for 20 h. Subsequently, it was no longer possible to detect any gelation on addition of a few drops of tetra-n-propyl orthotitanate to a small sample of the polymer, which indicates the completeness of the reaction. The mixture was neutralized by adding 2 mg of neodecanoic acid. The resulting polymer is storage-stable and can be used further without further workup.

### Preparation of Polymer 3

To 100 g of linear, vinyl-terminated PDMS having a viscosity of 65'000 mPa s was added 0.1 g of Karstedt's catalyst (Pt complex in xylene, Pt content 2%). The mixture was heated to 60° C., and 354 mg of trimethoxysilane was added dropwise. This was followed by heating to 80° C. and stirring of the mixture at this temperature for a further 4 h. A 1H NMR spectrum indicates the disappearance of the vinyl groups and hence completeness of the reaction. The resulting polymer is storage-stable and can be used further without further workup.

Tables 2 and 3 below contain overviews of the results.

TABLE 2

| | | | | Example 4 |
|---|---|---|---|---|
| | Example 1 | Example 2 | Example 3 | (comp.) |
| Polymer 1 | 100 | | | |
| Polymer 2 | | 100 | 100 | |
| Polymer 5 | | | | 100 |
| Silicone oil | 15 | 15 | 15 | 15 |
| Crosslinker 1 | 3.5 | 3.5 | 0.1 | 3.5 |
| Crosslinker 2 | 0.66 | 0.66 | 0.66 | 0.66 |
| Silica 1 | 8.7 | 8.7 | 8.7 | 8.7 |
| GCC | 57 | 57 | 57 | 57 |
| Catalyst 1 | 0.6 | 0.6 | 0.6 | 0.6 |
| Results | | | | |
| SOT [min] | 46 | 47 | >24 h | 14 |
| Through-curing in the | 4.5 | 5 | 0 | 5 |
| wedge (1 d) | | | | |
| Through-curing in the | 7 | 7 | 7.5 | 9 |
| wedge (3 d) | | | | |
| Through-curing in the | 12 | 12 | 12 | 13 |
| wedge (7 d) | | | | |
| Shore A (7 d) | 33 | 26 | 33 | 29 |
| Tensile strength | 1.5 | 1.59 | 1.5 | 1.61 |
| Elongation at break | 250 | 297 | 250 | 390 |
| Curing under movement | OK | OK | OK | cracked |

comp.: comparative example

TABLE 3

| | Example | | Example | Example | |
|---|---|---|---|---|---|
| | 5 | Example | 7 | 8 | Example |
| | (comp.) | 6 | (comp.) | (comp.) | 9 |
| Polymer 1 | | | | | 100 |
| Polymer 3 | | 100 | | | |
| Polymer 4 | 100 | | | | |
| Polymer 5 | | | 100 | 100 | |
| Silicone oil | 15 | 15 | 15 | 15 | 15 |
| Crosslinker 1 | 3.5 | 3.5 | 3 | 0 | 0.1 |
| Crosslinker 2 | 0.66 | 0.5 | 0.5 | 0.5 | 0.5 |
| Silylurea | | 2.5 | | | |
| Silica 2 | 8.7 | 10 | 10 | 10 | 10 |
| GCC | 57 | 50 | 50 | 50 | 50 |
| Catalyst 2 | 0.6 | 0.2 | 0.2 | 0.2 | 0.2 |
| Results | | | | | |
| SOT [min] | 32 | 40 | n.d. | 37 | n.d. |
| Through-curing in the | 4.5 | 6 | n.d. | 9 | n.d. |
| wedge (1 d) | | | | | |
| Through-curing in the | 7.5 | 10 | n.d. | 10 | n.d. |
| wedge (3 d) | | | | | |
| Through-curing in the | >10 | 18 | >10 | n.d. | 8 |
| wedge (7 d) | | | | | |
| Shore A (7 d) | 30 | n.d. | <10 | n.d. | 11 |
| Tensile strength | 1.6 | 1.16 | n.m. | 0.76 | 0.83 |
| Elongation at break | 360 | 442 | n.m. | 678 | 490 |
| Curing under | cracked | OK | Plastically | Plastically | OK |
| movement | | | deformed | deformed | |

comp.: comparative example
n.d.: not determined
n.m.: not measurable

It becomes clear from the results in the above tables 2 and 3 that compositions of the invention lead to good curing under movement. The use of noninventive polydiorganylsiloxanes having exclusively dialkoxysilyl-terminated siloxane chains leads to inhomogeneous depth curing and cracking or inadequate curing under movement. Interestingly, and surprisingly to the person skilled in the art, neither the assessment of elasticity on thin samples (as utilized for determination of tensile strength and elongation at break) nor the determination of through-curing time in a wedge permits any conclusion as to the homogeneity of depth curing and hence quality of curing under movement.

1. A moisture-curing silicone composition comprising
a) at least one crosslinkable polydiorganylsiloxane of the general formula I 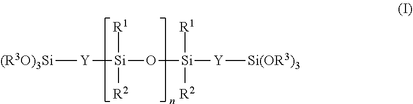
where R¹, R² and R³ are independently monovalent hydrocarbyl groups having 1-8 carbon atoms that may be substituted by F, N, P, O and/or S, Y is a divalent hydrocarbyl group having 1-8 carbon atoms, an oxygen atom or a group of the general formula (II) 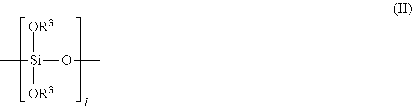
where R³ has the definition given above and 1=1-5,
and n is chosen such that the crosslinkable polydiorganylsiloxane has a viscosity at a temperature of 25° C. of 10-500,000 mPa s,
b) at least one condensation catalyst
c) at least one crosslinker having hydrolyzable radicals
d) optionally fillers
e) optionally further ingredients,
wherein polydiorganylsiloxanes of the general formula (I) account for at least 90% of the total mass of polydiorganylsiloxane present, and the polymer end groups Si(OR³) of the at least one polydiorganylsiloxane of the general formula (I) have a reaction rate in the crosslinking reaction that is at least equal to or higher than the hydrolyzable radicals of the at least one crosslinker.

2. The moisture-curing silicone composition as claimed in claim 1, wherein the crosslinkable polydiorganylsiloxane is prepared in a condensation reaction from OH-terminated polydiorganylsiloxane.

3. The moisture-curing silicone composition as claimed in claim 1, wherein the crosslinkable polydiorganylsiloxane is prepared in a condensation reaction from OH-terminated polydiorganylsiloxane and a tetraalkoxysilane.

4. The moisture-curing silicone composition as claimed in claim 1, wherein the crosslinkable polydiorganylsiloxane is prepared in a hydrosilylation reaction.

5. The moisture-curing silicone composition as claimed in claim 1, wherein the crosslinkable polydiorganylsiloxane is prepared directly in the mixing unit, and the further ingredients are metered and mixed in on conclusion of this preparation, without workup and/or intermediate storage of the crosslinkable polydiorganylsiloxane.

6. The moisture-curing silicone composition as claimed in claim 1, wherein the condensation catalyst is a compound of an element of groups 1, 2, 4, 12, 14 or 15 of the Periodic Table of the Elements.

7. The moisture-curing silicone composition as claimed in claim 1, wherein the at least one crosslinker having hydrolyzable radicals is selected from compounds of the general formula (III)
R⁴ₘSiX₄₋ₘ (III)
where R⁴ is independently a nonhydrolyzable monovalent hydrocarbyl radical having 1-18 carbon atoms, which is saturated or unsaturated and optionally has one or more functional groups containing the elements N, P, O and/or S, m is 0, 1, 2 or 3, X is independently an OH group, a linear or branched alkoxy group having 1-8 carbon atoms or a group of the general formula IV
N(SiR⁴ₘ)ₒ(R⁵)ₚ(R⁶)_{q} (IV)
where R⁴ and m have the definitions given above, R⁵ is a hydrogen atom or a monovalent hydrocarbyl group having 1-8 carbon atoms and R⁶ is an acyl group having 1-9 carbon atoms, and o, p, q are 0, 1 or 2, with the proviso that o+p+q=2.

8. The moisture-curing silicone composition as claimed in claim 7, wherein the at least one crosslinker is selected from hydrolysis and/or condensation products of compounds of the general formula (III).

9. The moisture-curing silicone composition as claimed in claim 1, wherein fillers are selected from natural, ground or precipitated calcium carbonates or chalks, silicas, hydroxide, carbon black, barium sulfate, dolomite, siliceous earths, kaolin, hollow beads, quartz, calcined aluminum oxides, aluminum silicates, magnesium aluminum silicates, zirconium silicates, cristobalite flour, diatomaceous earth, mica, titanium oxide, zirconium oxide, gypsum, graphite, zeolites, ground glass, carbon fibers, polymer fibers or glass fibers, and have optionally been surface-modified.

10. The moisture-curing silicone composition as claimed in claim 1, wherein further comprising at least one component selected from the group consisting of OH-terminated polydimethylsiloxanes, plasticizers, adhesion promoters, curing accelerators, OH scavengers, desiccants, wetting aids, rheology modifiers, thixotropic agents, processing aids, biocides, UV stabilizers, heat stabilizers, flame retardants, color pigments, odorants, antistats, and emulsifiers.

11. The moisture-curing silicone composition as claimed in claim 1, wherein the composition is a one-component silicone composition.

12. A two-component silicone composition comprising (i) a component A that includes
a) the at least one crosslinkable polydiorganylsiloxane of the general formula I 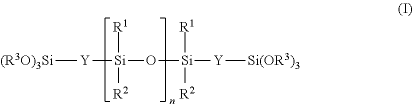
where R¹, R² and R³ are independently monovalent hydrocarbyl groups having 1-8 carbon atoms that may be substituted by F, N, P, O and/or S, Y is a divalent hydrocarbyl group having 1-8 carbon atoms, an oxygen atom or a group of the general formula (II) 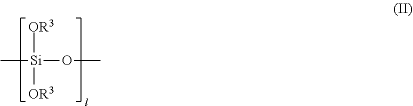
where R³ has the definition given above and 1=1-5,
and n is chosen such that the crosslinkable polydiorganylsiloxane has a viscosity at a temperature of 25° C. of 10-500,000 mPa s,
b) optionally fillers
c) optionally further ingredients
and (ii) a component B that includes
e) the at least one condensation catalyst
f) the at least one crosslinker having hydrolyzable radicals
g) optionally fillers
h) optionally further ingredients.

13. (canceled)

14. A method of bonding or joining substrates with the two-component silicone composition claimed in claim 12, comprising:
a) mixing component B into component A in order to obtain a mixture,
b) applying the mixture to a substrate and contacting the mixture applied to the substrate with a further substrate in order to obtain an adhesive bond between the substrates, or introducing the mixture into a joint between two substrates in order to obtain a joint between the substrates, and
c) curing the mixture.

15. A bonded or joined substrate obtainable by a method as claimed in claim 14.

16. A method of bonding or joining substrates with the moisture-curing silicone composition as claimed in claim 1, comprising:
a) applying the composition to a substrate and contacting the composition applied to the substrate with a further substrate in order to obtain an adhesive bond between the substrates, or introducing the composition into a joint between two substrates in order to obtain a joint between the substrates, and
c) curing the composition.
